(19) United States
(12) Patent Application Publication
(10) Pub. No.: US 2015/0121231 A1
(43) Pub. Date: Apr. 30, 2015

(54) Systems and Methods for Interactively Presenting a Presentation to Viewers

(71) Applicant: Promethean Limited, Blackburn (GB)

(72) Inventors: Andrew Edwardson, Bradford (GB); Andrew Pennington, Manchester (GB); Andrew Button, Blackburn (GB); Sriraman Venkataraman, Norcross, GA (US); Ben Titterington, Preston (GB)

(73) Assignee: PROMETHEAN LIMITED, Blackburn (GB)

(21) Appl. No.: 14/064,897

(22) Filed: Oct. 28, 2013

(51) Int. Cl. G06F 3/0484; G06F 17/24; G06F 17/21

(52) U.S. Cl. CPC G06F 3/04842; G06F 17/211; G06F 17/24
USPC 715/732

(57) ABSTRACT

A system and method that allows a user to interactively display a presentation to one or more viewers. The presentation system allows the presentation to be displayed on an interactive display while one or more mobile computing devices assigned to each viewer connects to the presentation system so that the viewer can view the presentation and also receive one or more slides from the presentation in real-time while the slide presentation is being presented. The received slides may be electronically editable versions of the slides being displayed or electronically editable versions of slides that contain subject matter related to the subject matter of the slides being displayed. The viewers can edit the electronically editable versions of the slides and send the edited versions back to the user during the presentation. The user may then optionally display one or more of the edited slides as part of the presentation.

### BACKGROUND

Presentation systems generally enable a user to create a presentation using a slide presentation software package and display the presentation (e.g., as a slideshow) as series of pre-set (e.g., static) slides to one or more viewers or participants. While such presentation systems may be useful, the presenter may desire a more dynamic way to display the presentation such as pushing different parts of the information out to subgroups of viewers.

Various embodiments of the present systems and methods recognize and address the foregoing considerations, and others, of prior art systems and methods.

### SUMMARY OF THE INVENTION

In an embodiment, the invention is directed to a computer-implemented method of presenting information to at least two groups of viewers. Each viewer in the two groups of viewers is using a mobile computing device. The method includes one or more of the steps of (1) receiving a selection by a user of a slide presentation that the user wishes to present to the two groups of viewers, where the slide presentation includes one or more slides; (2) generating a code that is associated with either the user or the slide presentation; (3) facilitating presentation of the code and the slide presentation to the two groups of viewers (e.g., displaying the slides on an interactive display such as an interactive whiteboard); (4) receiving the code and an identifier that is unique to each mobile computing device associated with each viewer; (5) generating a session code for the presentation of the slides; (6) displaying the slides on at least one interactive display; and (7) during the presentation of the slides, distributing first electronic information to a first group of viewers using the first session code and a group identifier, and second electronic information to a second group of viewers using the session code and second group identifier.

In various embodiments the first and second electronic information may each be one particular electronically editable version of a slide in the slide presentation. In other embodiments, the first electronic information may be an electronically editable version of a first particular slide and the second electronic information may be an electronically editable version of a second particular slide. The first and second particular slides may each be a respective version of slides that are displayed to the viewers during the presentation, or they may be slides that contain subject matter that relates to the subject matter in the slide presentation, but the slides are not necessarily displayed on the interactive display during the presentation.

In some embodiments, the viewer can edit the electronically editable version of the slide during the presentation by using a mobile device assigned to the viewer and send the edited version of the slide back to the user. The viewer may send the edited version of the slide back during the presentation, or in various embodiments, the viewer may send the edited version of the slide back to the user after the presentation is completed.

### BRIEF DESCRIPTION OF THE DRAWINGS

A full and enabling disclosure of the present invention, including the best mode thereof directed to one of ordinary skill in the art, is set forth in this specification, which makes reference to the appended drawings, in which:

FIG. 1 a is block diagram of an exemplary system that allows a user to interactively present a presentation to a group of viewers in accordance with an embodiment of the present system;

FIG. 2 is a block diagram of a computer that may be used, for example, as the host server within the context of the system of FIG. 1;

FIG. 3 comprises a flow diagram illustrating an exemplary presentation process performed by the system of FIG. 1; and

FIG. 4 illustrates an exemplary user experience when the user is registering with the present system of FIG. 1;

FIG. 5 illustrates an exemplary user experience when the user is logging in to the present system of FIG. 1;

FIGS. 6-8 illustrate an exemplary user experience when the user is first setting up their account settings the present system of FIG. 1;

FIG. 9 illustrates an exemplary user experience when the user sets up their classes on the present system of FIG. 1;

FIG. 10 illustrates an exemplary user experience when the user selects a presentation to display to viewers using the present system of FIG. 1;

FIG. 11 illustrates an exemplary user experience when the selected presentation in FIG. 10 begins to display;

FIG. 12, illustrates and exemplary user experience when the user desires to interactively distribute a slide to one or more viewers of the presentation; and

FIG. 13 illustrates another exemplary user experience when the user desires to interactively distribute a slide to all viewers of the presentation.

### DETAILED DESCRIPTION OF SOME EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made to the present invention without departing from the scope or spirit thereof. For instance, features illustrated or described as part of one embodiment may be used in another embodiment to yield a still further embodiment. Thus, the present invention covers such modifications and variations as come within the scope of the appended claims and their equivalents.

### Overview

In one particular embodiment, the presentation system runs one or more modules that provide an interactive classroom (e.g., teaching/learning) experience. The modules(s) may include, but is not limited to: 1) a lesson building module that a user (e.g., a third party slide presentation creator, the teacher, etc.) uses to create a slide presentation (e.g., a lesson); 2) a presentation module that the teacher uses to display/present the slide presentation; and 3) a learner module that, in a particular embodiment, runs on the mobile computing device that is used by a student to view and/or interact with the slide presentation. In various embodiments, each of the modules may be web-browser based.

In various embodiments, when the teacher sets up a class/classroom for the first time on the presentation system, the teacher logs into the presentation system using a presentation device (e.g., a computer connected to an interactive device), and enters data about the class/classroom and/or the students, and the presentation system assigns an identification number (e.g., a class code) for the particular class being taught by the teacher. The class ID may be a fixed code that is assigned to the class for the duration of the class (e.g., a school year, a semester, etc.). Thus, when the teacher is ready to present a particular lesson to the class, the teacher signs into their account on the presentation system using the presentation device and selects the class and the particular slide presentation to present. Once the teacher selects the class and slide presentation, the presentation system provides the class ID (e.g., the class code) to the presentation device, which displays the class ID on the interactive display. Each time the teacher selects a slide presentation and a class in which to present the slide presentation, the unique class ID is displayed on the interactive display for the selected class. For example, if a teacher presents a new slide presentation to the same class each day (e.g., a teacher teaches new material in a math class every day to the same students), each of the slide presentations for each day shares the same class ID as long as the teacher is presenting to the same class.

Additionally, each time a teacher selects a class and a presentation to present, the presentation system establishes a session (e.g., an instance in time when a teacher is presenting a slide presentation to a class). Each session is assigned a session ID by the presentation system, which allows each computing component (e.g., the presentation device, the student's mobile computing devices, a presentation controller and a host server) in the presentation system to communicate with one another during the session. Thus, when students log into the presentation system on their mobile computing device using the class ID and information that identifies the student (e.g., the student's name, device identification information, student ID, etc.), their mobile computing devices communicate with the presentation system using the session code. The session ID stays active until the teacher closes the session (e.g., logs out of the system, ends the slide presentation, selects a new class, etc.).

The presentation system may also be configured to allow a teacher to distribute electronically editable slides using the session ID. For example, a teacher may send an electronically editable version of a particular slide of the slide presentation to one or more students viewing the presentation. The students receive the electronically editable version of the slide on their mobile computing device and can edit or manipulate objects in the slide, or respond to questions presented on the slide using the mobile computing device. Once the students complete a requested task associated with the electronically editable version of the slide, the presentation system is configured to receive edited versions of the electronically editable slides from the students' mobile computing device.

The presentation system may also be configured to allow the teacher to create groups of students by using the session ID. In various embodiments, the presentation system appends a group identifier to the end of the session ID for each group created on the system. The presentation system may automatically determine groups based on one or more student attributes (e.g., learning abilities, prior test scores, grade point averages, answers to questions asked during the presentation, etc.), or the teacher may manually set up the groups either when the slide presentation is created or during the presentation of the slide presentation. Creating groups may allow the teacher to transmit (e.g., push) different electronic material (e.g., electronically editable slides, electronically editable tests, etc.) to each group of students.

While the above example is directed to use of the presentation system in a classroom setting, the presentation system may also be used in a business setting (e.g., during a company presentation, seminar, workshop, etc.). In business environments, instead of the code being associated with a class, each unique code is associated with the presentation. Otherwise, the system generally operates similar to the discussion above.

### Exemplary Technical Platforms

As will be appreciated by one skilled in the relevant field, the present systems and methods may be, for example, embodied as a computer system, a method, or a computer program product. Accordingly, various embodiments may be entirely hardware or a combination of hardware and software. Furthermore, particular embodiments may take the form of a computer program product stored on a computer-readable storage medium having computer-readable instructions (e.g., software) embodied in the storage medium. Various embodiments may also take the form of web-implemented computer software. Any suitable computer-readable storage medium may be utilized including, for example, hard disks, compact disks, DVDs, optical storage devices, and/or magnetic storage devices.

Various embodiments are described below with reference to block diagram and flowchart illustrations of methods, apparatuses (e.g., systems), and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, a special purpose computer, or other programmable data processing apparatus to produce a machine. As such, the instructions which execute on the general purpose computer, special purpose computer, or other programmable data processing apparatus can direct a computer or other programmable data processing apparatus to function in a particular manner such that the instructions stored in the computer-readable memory produce an article of manufacture that is configured for implementing the functions specified in the flowchart block or blocks.

The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including: a local area network (LAN); a wide area network (WAN); a cellular network; or the connection may be made to an external computer (for example, through the Internet using an Internet Service Provider).

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

### Example System Architecture

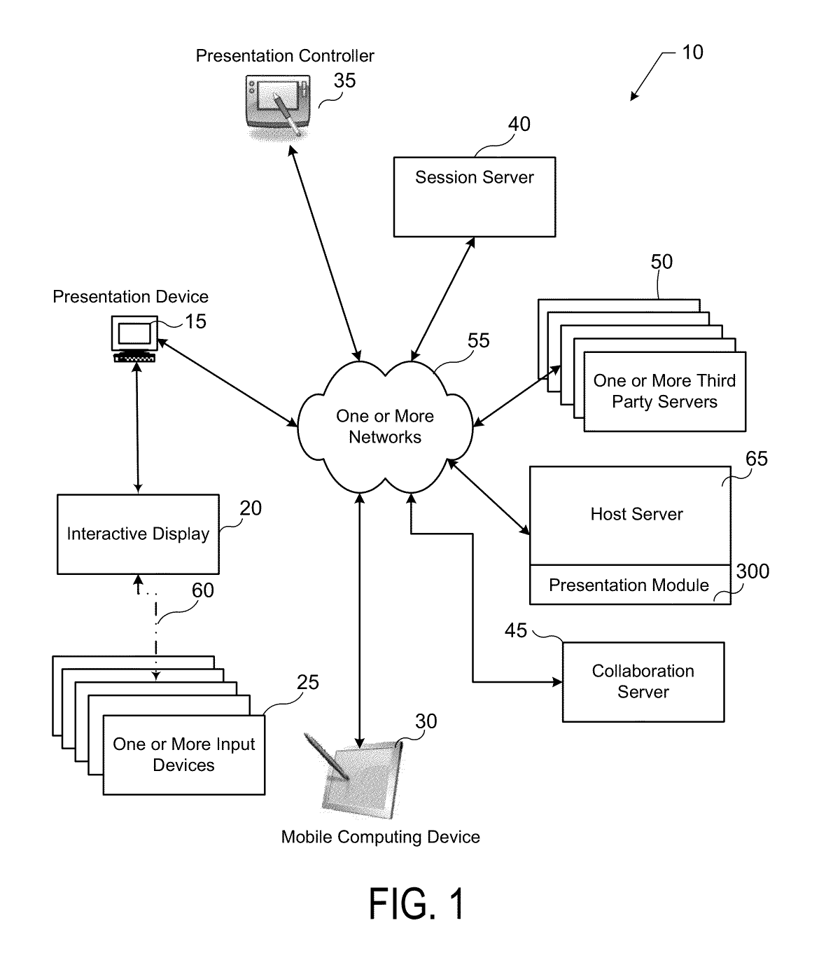

FIG. 1 is a block diagram of a presentation system 10 according to a particular embodiment that is configured for creating slide presentations and presenting the slide presentations to one or more viewers. As may be understood from this figure, the presentation system 10 includes a presentation device 15 (which may be, for example, a desktop computer, a laptop computer, a mobile computing device, etc.), one or more mobile computing devices 30 (e.g., a tablet, a smart phone, a laptop, a wearable computing device, etc.), a presentation controller 35 (e.g., a laptop, a tablet, a smartphone, a desktop computer, a wearable computing device, etc.), a session server 40, a collaboration server 45, one or more third party servers 50, an interactive display 20 and/or a host server 65. The presentation device 15, presentation controller 35, session server 40, collaboration server 45, one or more third party servers 50, host server 65 and mobile computing devices 30 communicate with one another over one or more networks 55. The session server 40, collaboration server 45, one or more third party servers 50 and host server 65 may be any suitable computer device (e.g., a desktop computer, a laptop computer, etc.). The host server 65 comprises one or more modules (e.g., presentation module 300).

The one or more networks 55 may include any of a variety of types of wired or wireless computer networks such as the Internet, a private intranet, a mesh network, a public switch telephone network (PSTN), or any other type of network (e.g., a network that uses Bluetooth or near field communications to facilitate communication between computers). The one or more networks 55 may be a local area network (LAN), a wide area network (WAN), a cellular network, and/or the connection may be made to an external computer (for example, through the Internet using an Internet Service Provider). In particular embodiments, the one or more networks 55, together with the host server 65, the session server 40, and the collaboration server 45, facilitate communication between the presentation device 15, mobile computing devices 30, the presentation controller 35, the one or more third party servers 50, and/or the host server 65, as described in more detail herein.

The presentation device 15 is operatively connected to the interactive display 20 by a universal serial bus (USB). In other embodiments, the presentation device 15 may be operatively connected to the interactive display 20 by Wi-Fi, Bluetooth, or any suitable wireless protocol type connection. The interactive display 20 may be, for example, any suitable display device with input/output capabilities. In a particular embodiment, the interactive display 20 is an interactive whiteboard that is touch and/or pen input enabled, such as those produced by Promethean World Plc (Promethean, Ltd.). An example of an interactive whiteboard is described in U.S. Pat. No. 8,325,162 to Promethean Ltd., which is incorporated by reference herein in its entirety. It should be understood, in light of this disclosure, that the interactive display 20, in one or more embodiments, is an interactive display other than a whiteboard, such as a computer monitor, which may or may not be touch-enabled, a touch screen computer, an interactive table display, a projector with a screen having one or more input sensor (e.g., a light curtain), a television operatively connected to one or more motion sensing devices, etc. In particular embodiments, the presentation device 15 may be omitted and the interactive display 20 (e.g., an interactive whiteboard, smart TV, or other suitable display) may perform the functions carried out by the presentation device 15.

One or more input devices 25 are operatively coupled to the interactive display 20 by a wireless connection 60. In various embodiments, the input devices 25 may be wirelessly connected to the presentation device 15, or through any other network connection to various other components in the presentation system 10. The input devices 25 are configured to receive input from viewers of a presentation and transmit the input to the interactive display 20. One example of an input device 25 is an ActivExpression™ or ActiVote™ device manufactured by Promethean World Plc (Promethean Ltd.).

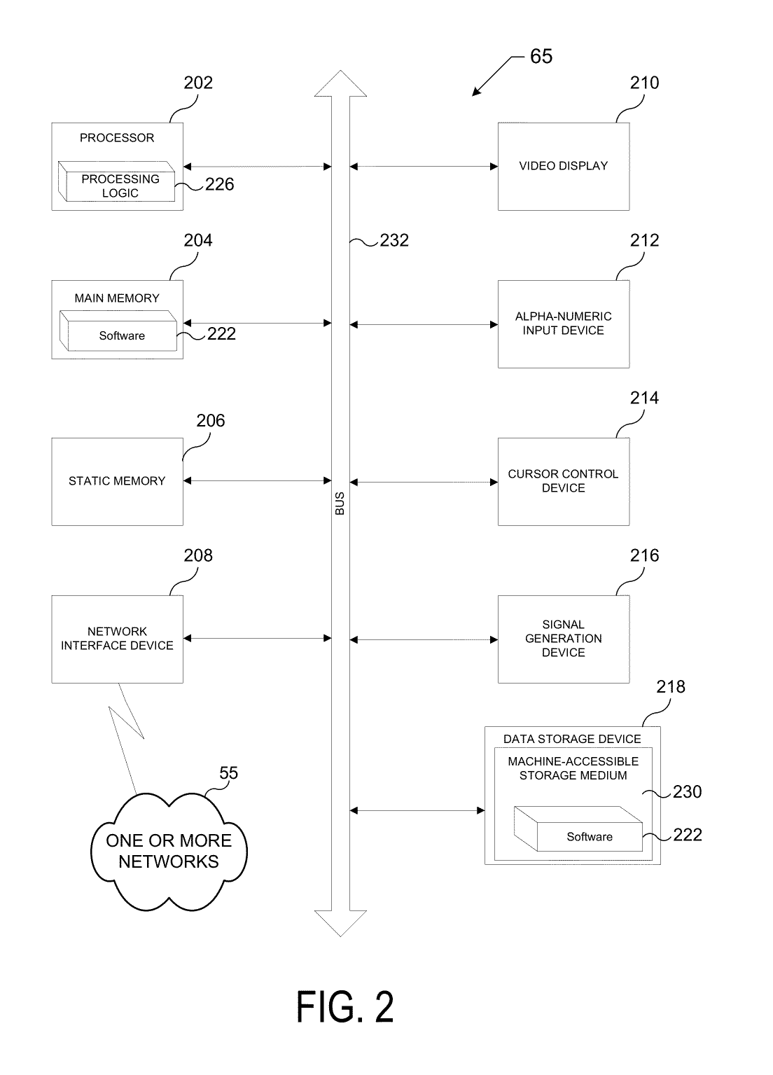

FIG. 2 provides a more detailed view of a computing device that may be used, for example, within the presentation system 10 as a suitable host server 65. However, it should be understood that similar computing devices may be used as one or more of the system's other computer components (e.g., presentation controller 35, session server 40, collaboration server 45, mobile computing device 30 and presentation device 15).

In particular embodiments, the host server 65 may be connected (e.g., networked) to one or more other computers via a LAN, an intranet, an extranet, and/or the Internet (e.g., one or more networks 55). As noted above, the host server 65 may operate in the capacity of a client computer in a client-server network environment, and/or as a peer computer in a peer-to-peer (or distributed) network environment. The host server 65 may be a desktop personal computer (PC), a tablet PC, a set-top box (STB), a Personal Digital Assistant (PDA), a cellular telephone, a web appliance, smart TV, an interactive whiteboard, a server, a network router, a switch or bridge, or any other computer capable of executing a set of instructions (sequential or otherwise) that specify actions to be taken by that computer. Further, while only a single computer is illustrated, the term “computer” should also be understood to include any collection of computers that individually or jointly execute a set (or multiple sets) of instructions to perform any one or more of the methodologies discussed herein.

An exemplary host server 65 includes a processor 202, a main memory 204 (e.g., read-only memory (ROM), flash memory, dynamic random access memory (DRAM) such as synchronous DRAM (SDRAM) or Rambus DRAM (RDRAM), etc.), a static memory 206 (e.g., flash memory, static random access memory (SRAM), etc.), and a data storage device 218, which communicate with each other via a bus 232. The host server 65 may further include a network interface device 208, a video display unit 210 (e.g., a liquid crystal display (LCD) or a cathode ray tube (CRT)), an alphanumeric input device 212 (e.g., a keyboard), a cursor control device 214 (e.g., a mouse), and a signal generation device 216 (e.g., a speaker)).

The processor 202 represents one or more general-purpose processors such as a microprocessor, a central processing unit, or the like. More particularly, the processor 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processor 202 may also be one or more special-purpose processors such as an application specific integrated circuit (ASIC), a field programmable gate array (FPGA), a digital signal processor (DSP), network processor, or the like. The processor 202 may be configured to execute processing logic 226 for performing various operations and steps discussed herein.

The data storage device 218 may include a machine-accessible storage medium 230 (also known as a non-transitory computer-readable storage medium or a non-transitory computer-readable medium) on which is stored one or more sets of instructions (e.g., software 222) embodying any one or more of the methodologies or functions described herein. The software 222 may also reside, completely or at least partially, within the main memory 204 and/or within the processor 202 during execution thereof by the host server 65—the main memory 204 and the processor 202 also constituting computer-accessible storage media. The software 222 may further be transmitted or received over the network 55 via a network interface device 208.

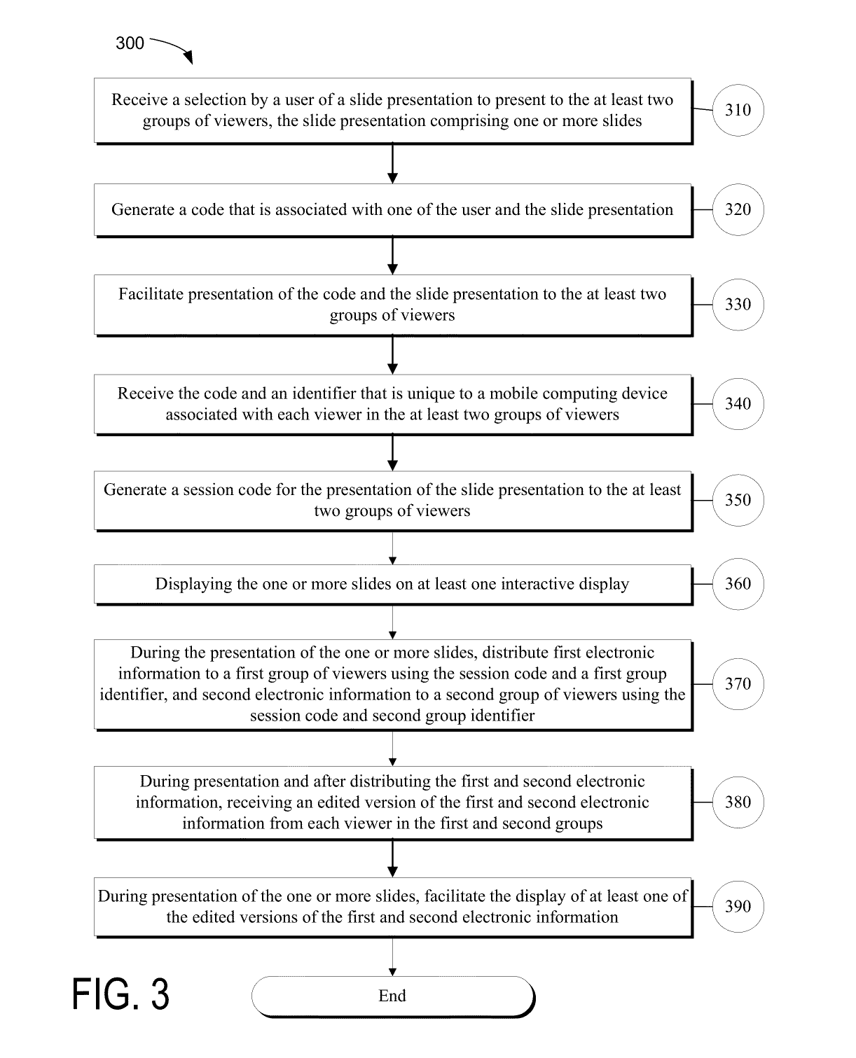

The software 222 may represent any number of program modules, including, but not limited to an operating system (not shown), a presentation builder module (not shown), a learner module (not shown), the presentation module 300 (see FIG. 3). It should be understood that these modules are merely exemplary and may represent a number of program modules that control certain aspects of the operation of the host server 65 (or other system computers, or other computers outside the system). Operation of the presentation module 300 is discussed in further detail below.

While the machine-accessible storage medium 230 is shown in an exemplary embodiment to be a single medium, the term “computer-accessible storage medium” should be understood to include a single medium or multiple media (e.g., a centralized or distributed database, and/or associated caches and servers) that store the one or more sets of instructions. The term “computer-accessible storage medium” should also be understood to include any medium (transitory of non-transitory) that is capable of storing, encoding or carrying a set of instructions for execution by the computer and that cause the computer to perform any one or more of the methodologies of the present system. The term “computer-accessible storage medium” should accordingly be understood to include, but not be limited to, solid-state memories, optical and magnetic media, etc.

### Exemplary Presentation Method

The system of FIG. 1 may be configured to perform the method steps of FIG. 3. Moreover, the method described in FIG. 3 is an example of an embodiment of a present method for presenting a slide presentation to one or more viewers. It should be understood by reference to this disclosure that the method describes an exemplary embodiment of the method steps carried out by the present system, and that other exemplary embodiments may be created by adding other steps or by removing one or more of the method steps described in FIG. 3.

FIG. 3 depicts an exemplary method for interactively presenting a slide presentation to one or more viewers. The method begins at step 310 when the host server 65 receives a selection, by a user, of a slide presentation to present to viewers, where the slide presentation comprises one or more slides. In various embodiments, the user may select the slide presentation from one or more slide presentations that are associated with a user's account on the presentation system 10. In other embodiments, the selected slide presentation may be a slide presentation that the user selects from a plurality of slide presentations that are stored on one of the third party servers 50.

At step 320, the host server 65 generates a code that is associated with either the user or the selected slide presentation. In preferred embodiments where the slide presentation is a lesson given to students of a class, the user is a teacher, the viewers are students, and the code is associated with the particular class that the teacher is teaching. In these embodiments, the code may be valid for the duration of the class (e.g., semester, trimester, school year, etc.). In other embodiments where the selected slide presentation is a presentation that is given by a business person to a group of colleagues, the code may be associated with the presentation, which remains valid until the presentation is deleted from the system. In these embodiments, if a copy of the presentation is generated by the system, a new code is generated by the host server 65 and assigned to the copy of the presentation. In still other embodiments, the code may be associated with the user presenting the presentation. That is, the code is generated by the host server 65 and assigned to the user's account so that each time the user is presenting a presentation, the user's code is displayed by the system.

At step 330, the host server 65 facilitates presentation of the code and the slide presentation to the at viewers. In a preferred embodiment, the host server 65 facilitates display of the code prior to the presentation of the one or more slides. In other embodiments, the system may display the code substantially simultaneously with display of the slide presentation. That is, in these embodiments, the introduction slide may be displayed substantially simultaneously with the code. In a preferred embodiment, facilitating presentation of the code and the slide presentation further comprises displaying the code and the one or more slides on the interactive display 20. In this embodiment, the interactive display 20 is an interactive whiteboard and the code and the presentation are projected onto the interactive whiteboard. In other embodiments, the interactive display may be a touch monitor, a tablet, an interactive television, or any other suitable interactive display connected to an interactive device such as a mouse, a light curtain, a pen input, or a gesture input device (e.g., a Kinect™ controller).

In a particular embodiment, each of the viewers of the presentation has a mobile computing device (e.g., a tablet, a smart phone, etc.) associated with the viewer. Using the mobile computing device, the viewer can download an application program that will allow them to enter the code and communicate with the host server 65. Once the viewer enters the code, at step 340, the host server 65 receives both the code and a unique identifier associated with the mobile computing device. In various embodiments, the unique identifier may comprise a Media Access Control Address (MAC address) of the mobile computing device or some other identifier specific to the mobile computing device (e.g., the device UDID, the device serial number, etc.). In other embodiments, the unique identifier may also contain information specific to the viewer (e.g., one or more of the viewer's name, student ID, employee ID, or any other suitable ID associated with the viewer).

At step 350, the host server 65, in combination with the session server 40, generates a session code that is unique to the presentation of the slide presentation. The session code is associated with a session (e.g., a period of time when a slide presentation is being presented, a class, etc.). Thus, a session is an abstraction of time when the various computing devices for a presentation (e.g., presentation device 15, presentation controller 35, mobile computing devices 30 and the host server 65) interact with each other. In various embodiments, each session may be unique and represented by a session code that is valid for a specific duration. In one or more embodiments, the duration of a session may last from a few minutes to several weeks or months. For example, a session may be established for a short period of time (e.g., minutes) to distribute homework, and in other embodiments, the session may last for an hour (e.g., the length of a classroom period). In various embodiments, the session server 40 manages the various computing devices associated with a presentation during the session. In various embodiments, the session server 40 provides application program interfaces for one or more of the various computing devices to start a session, stop a session, join a session, disconnect a session, pause a session and terminate a session. In a preferred embodiment, each of the various computing devices communicates with one another using the session code.

At step 360, the host server 65, in combination with the session server 40 and the collaboration server 45, displays the one or more slides on the interactive display 20. In various embodiments, the session server 40 works together with the collaboration server 45 to broadcast the presentation from the host server 65 to one or more of the presentation device 15, the presentation controller 35, and the mobile computing devices 30. In various embodiments, viewers may be located in the same room as the interactive display 20 or they may be located anywhere in the world so long as they are connected via the one or more network 55 (e.g., the Internet).

During the presentation of the one or more slides, at step 370, the host server 65, in combination with the session server 40 and the collaboration server 45, distributes (1) first electronic information to a first group of viewers using the session code and a first group identifier, and (2) second electronic information to a second group of viewers using the session code and second group identifier. In a particular embodiment, the host server 65, in combination with the session server 40, distinguishes between the first group of viewers and the second group of viewers by appending the first group identifier to the session code for the first group and appending the second group identifier to the session code for the second group. In this way, the first electronic information can be addressed to one or more specific mobile computer devices for viewers in the first group, and the second electronic information can be addressed to one or more specific mobile computing devices of viewers in the second group.

In various embodiments, viewers may be selected for the first and second group either automatically by the host server 65 based on various information and criteria. For example, in embodiments where the user is a teacher, the presentation is a lesson and the viewers are students, the viewers may be automatically selected to be in a group based on one or more of (1) at least one response to a question asked during presentation of the one or more slides, (2) random selection, (3) the viewer's grade point average, (4) the viewer's style of learning, (5) the viewer's primary language, (6) the viewer's prior test results, and (7) information from social networks. In particular embodiments, the host server 65 may be configured to receive information from one or more third party servers that store one or more of the above listed criterion.

In some embodiments, the host server 65 may be configured to receive information from social networks regarding viewers. Thus, in embodiments where the slide presentation is presented in a business setting (e.g., a conference, seminar or workshop), the host server 65 may prevent viewers that are connected on a social networking sites or that work together from being placed in the same group of viewers to encourage networking between viewers that have no known previous relationship.

In some of the above embodiments, viewers may also be manually placed into groups by the user. Thus, in the classroom example, the teacher may prospectively group students when the teacher is creating the slide presentation. For example, in some of these embodiments, the teacher may group the students based on personal knowledge of the student's abilities. For example, some students may be advanced, some students may be slower at learning new material and for other students, English may be their second language. As a result, each group of students may be formed manually by the teacher prior to presenting the slide presentation by using, for example, the presentation device 15 or the presentation controller 35. In other embodiments, the teacher may manually assign students to groups during presentation of the slide presentation. In these embodiments, the teacher may select students indirectly on the presentation device 15 using the interactive display 20 or directly using the presentation controller 35.

During the presentation of the one or more slides and after distributing the first and second electronic information, at step 380, the host server 65, in combination with the session server 40 and the collaboration server 45, is configured to receive an edited version of the first and second electronic information from each viewer in the first and second group. In various embodiments, the mobile computing devices 30 are configured to send the edited version of the first and second electronic information to the host server 65. In other embodiments, the host server 65 is configured to poll the mobile computing devices 30 to pull the edited versions of the first and second electronic information from the mobile computing devices.

Also during presentation of the one or more slides and after receiving the edited versions of the first and second electronic information, the host server 65, at step 390, facilitates the display of at least one of the edited versions of the first and second electronic information. In a particular embodiment, the first and second electronic information are the same electronically editable version of one particular slide from the one or more slides of the presentation. In another preferred embodiment, the first electronic information is an electronically editable version of a first particular slide from the one or more slides and the second electronic information is an electronically editable version of a second particular slide from the one or more slides. In some of these embodiments, the one particular slide may be a slide that is displayed to the viewers and in other embodiments, it may be a slide that is part of the slide presentation but not necessarily a slide that is displayed to the viewers. For example, the slide presentation may contain one or more slides that are associated with slides that are displayed to the viewers. In these embodiments, these slides may contain one or more notes, questions, or test questions that cover the subject matter covered by the displayed slides, etc. Thus, while these slides are part of the presentation, they are slides that are configured to be distributed to the viewers on mobile computing devices 30 as electronically editable slides as opposed to being displayed to the viewers on the interactive display 20.

In particular embodiments where the first and second electronic information is an electronically editable version of one particular slide, host server 65, in combination with the session server 40 and the collaboration server 45 (1) receives edited versions of the one particular slide from the mobile computing devices 30 and (2) facilitates display of one or more of the edited versions on the interactive display 20. In other embodiments where the one particular slide is a slide that is being displayed on the interactive display 20, the host server 65, in combination with the session server 40 and the collaboration server 45, may be configured to receive the edits made by at least one of the viewers and to substantially simultaneously (e.g., simultaneously) display those edits on the one particular slide that is displayed on the interactive display 20 as the selected viewer makes the edits using their mobile computing device 30.

### Exemplary User Experiences

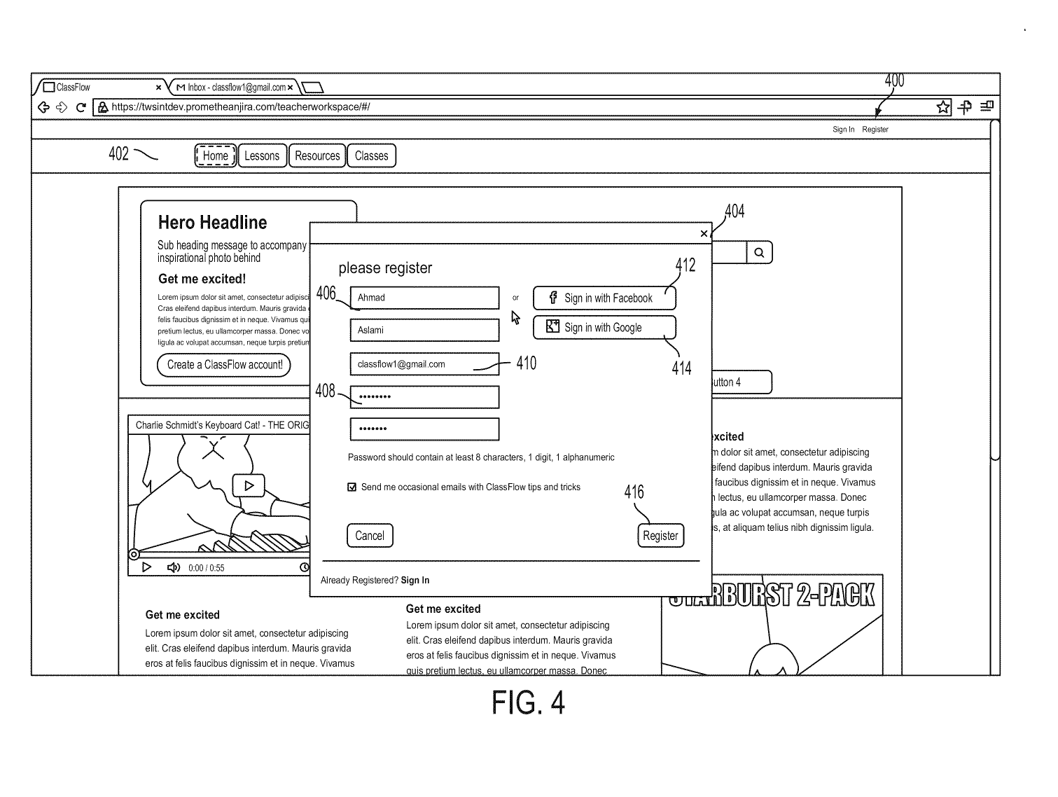

FIGS. 4-13 depict screen shots of various features of the present systems and methods included in various embodiments. In particular, the screen shots of FIGS. 4-12 show how a user (e.g., a teacher or other presenter) may use the presentation system to set up and display a presentation (e.g., lesson) to one or more viewers (e.g., students or other viewers). It should be understood that although the following discussion describes having a teacher set up and present one or more lessons to students, the following examples may apply to any type of presentation in any suitable context.

FIG. 4 depicts an account registration menu 404 for allowing a user to open an account on the presentation system 10. If the user is new to the system, the user can navigate to a website 402 for the presentation system 10 and select a register link 400, which opens the account registration menu 404. The account registration menu 404 includes a name field 406 that allows the user to enter their name, a password field 408 that allows the user to select a password, and an e-mail address field 410 that allows the user to enter an e-mail address to be associated with the user's account. Alternatively, instead of registering by entering the user's name, e-mail address and password, etc., the account registration menu 404 also allows the user to register with the presentation system 10 using either Facebook 412 or Google 414. If the user chooses to register by entering their name, password and e-mail address, they would select the register button 416 when the fields are completed. If instead the user chooses to register using their Facebook or Google account, the system would open a login screen (not shown) that allows the user to enter their login information for the respective service.

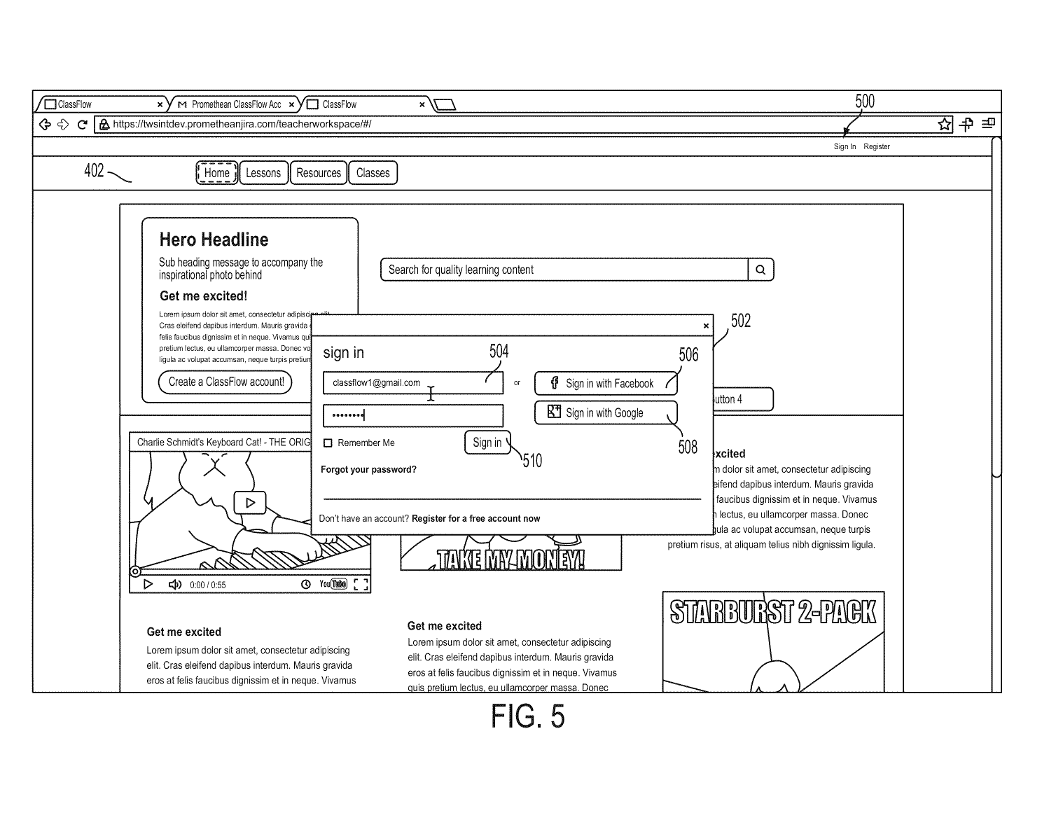

Referring to FIG. 5, once a user is registered with the presentation system 10, they can navigate to the website 402 and select a sign-in link 500, which opens the sign-in screen 502. The sign-in screen 502 provides an area 504 for the user to enter their e-mail address and password, after which they can select the sign-in button 510. If, instead, the user chooses to log in using Facebook or Google, the user can select one of a Facebook button 506 and a Google button 508 to log into the system using their credentials for the respective service.

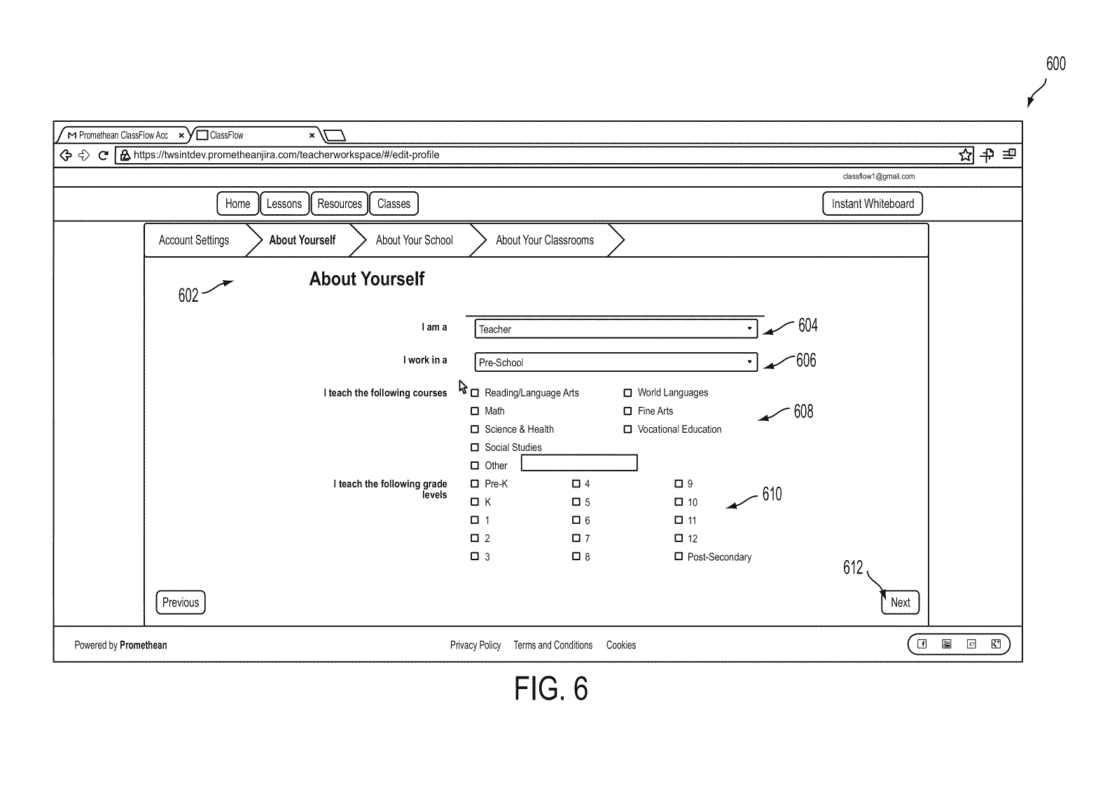

Referring to FIG. 6, when a user signs-in for the first time, an account setting screen 600 opens that allows the user to enter information about themselves on an About Yourself screen 602. In the case where the user is a teacher that teaches class at a school, the user can select that they are a teacher at 604, select the type of school the work in at 606, select the types of subjects they teach, and select the grade levels they teach at 610. Once the user enters the information about them, the user can select a Next button 612, which takes them to the next account setting screen.

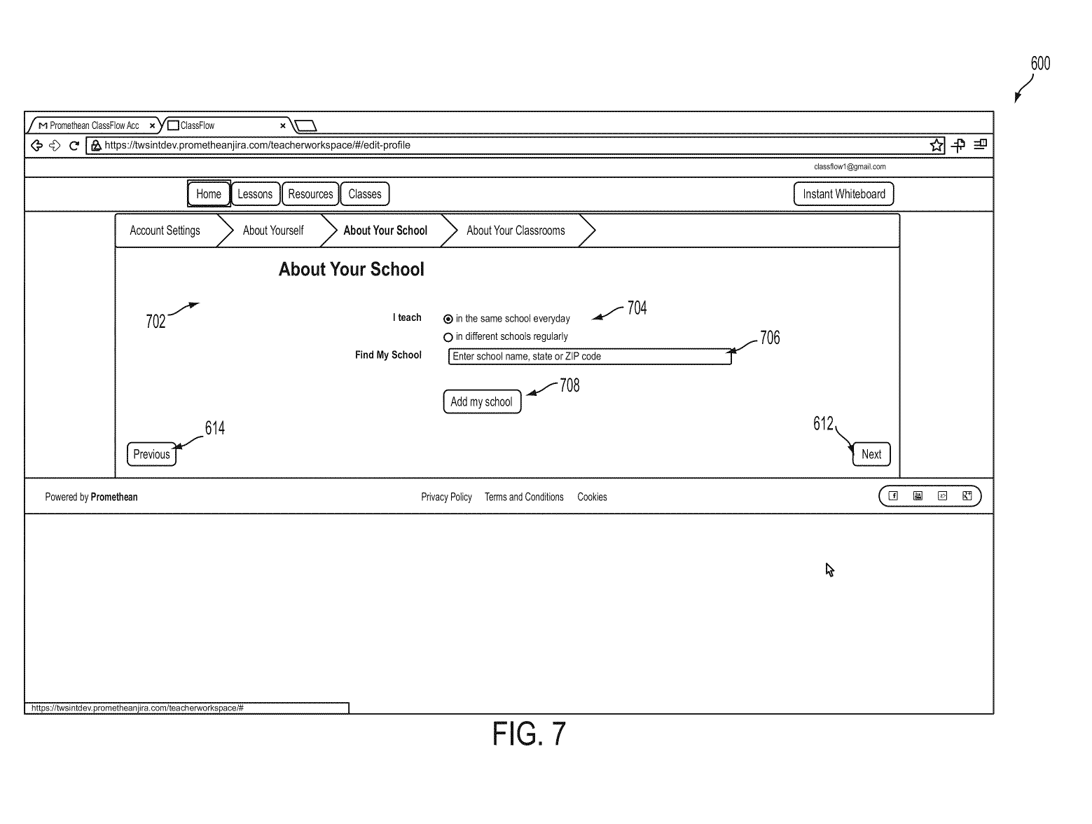

Referring to FIG. 7, after hitting the next button 612, the system stays on the account setting screen 600, but moves to the next account setting page entitled About Your School 702. On this page, the user can select at 704 whether they teach in the same school each day or whether they regularly teach in a different school. The user can also begin typing the name of their school at 706, which will bring up a list of schools that match the portion of the word typed in the entry field at 706. If the user cannot locate their school, an Add School button 708 opens a screen that allows the user to add their school to the list of available schools. If the user needs to go back to the previous screen to change data, the user can select a Previous button 614. Otherwise, once the About Your School page is completed, the user selects the Next button to move to the next account setting screen.

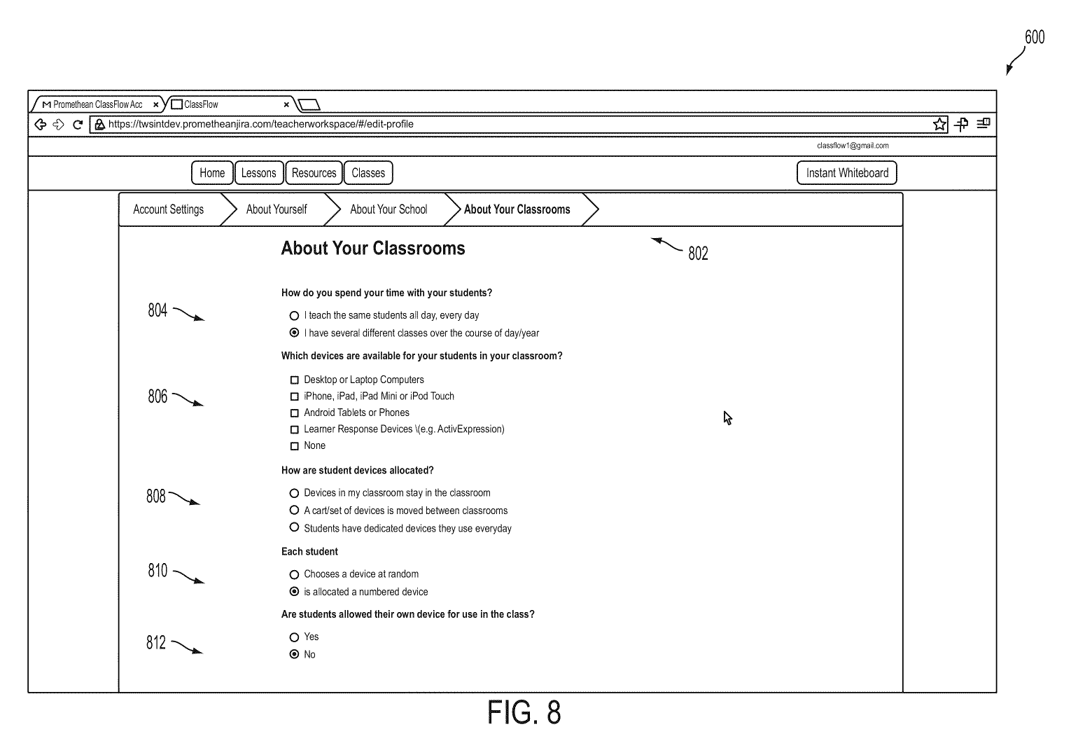

Referring to FIG. 8, the last account setting screen is an About Your Classroom screen 802 that asks specific questions about the user's classroom. In particular, at 804, the user is asked whether they teach the same students all day or if they have several different classes of the course of a day and year. At 806, the user is asked to select the types of devices that are available to the students in the classroom. The user can select one or more from a list consisting of desktop/laptop computers, Apple devices, Android devices, or no devices. At 808, the user is asked how the student devices are allocated. The user may select whether the devices stay in the classroom, the devices move between classrooms, or if the devices are assigned to a particular student. At 810, the user selects whether each student chooses a device at random or is allocated a numbered device. The input received on the About Your Classroom screen 802 allows the presentation system 10 to correctly configure sessions, connection of devices and tracking students when the log in to the system using the classroom devices.

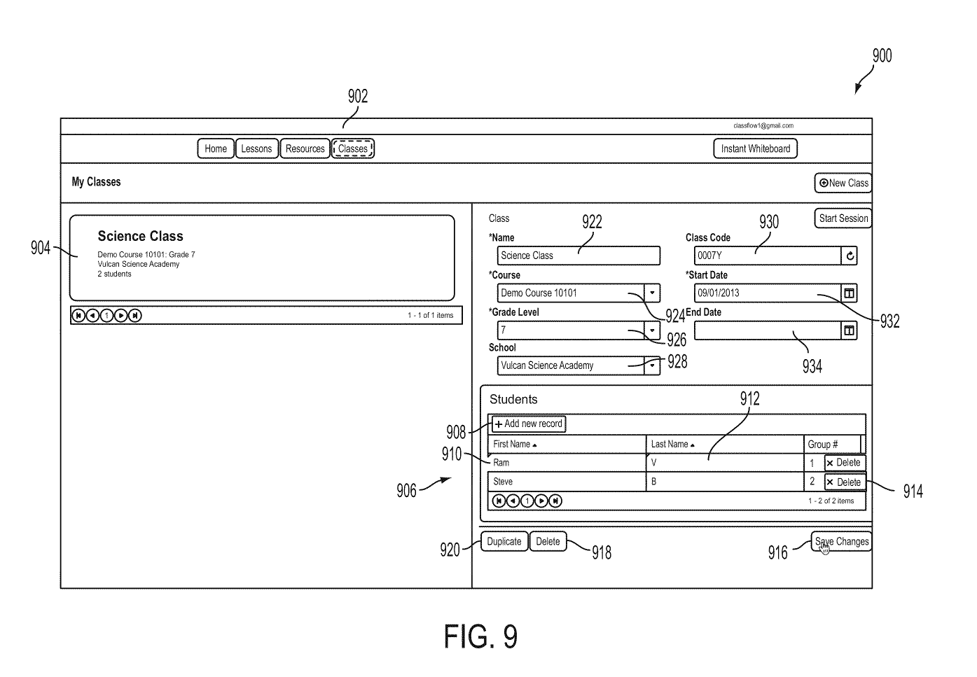

FIG. 9 depicts a class setup screen 900 for setting up a class (e.g., for a classroom of students, for a series of presentations, for a series of lectures, etc.). The class setup screen 900 includes a plurality of navigation options 902, such as “Home,” “Lessons,” “Resources,” and “Classes.” The navigation options 902 enable a user to navigate to various sections of the program. The class setup screen 900 also includes a class identifier section 904, which displays a particular class taught by the teacher and several additional details about the class, such as course number, the grade, the name of the school and the number of students (e.g., as populated from a student information section 906).

The class setup screen 900 includes the student information section 906 in which a teacher may populate a list of students in the class. The teacher can add students to the student information section using the Add New Record Button 908, which creates a new student record in a database of students. The teacher can then add each student's first name 910 and last name 912. The teacher can delete a student record by using the delete button 914. Additionally, the teacher may duplicate or delete an entire student information section 906 using the duplicate button 920 or delete button 918, respectively. Finally, the teacher may manually add students to a particular group by entering a group number at 922. The group number field 922 allows a teacher to prospectively assign students to a class group prior to the presentation of a lesson. The teacher may, at any time, save changes to the student information section 906 using the save changes button 916.

In addition to adding students to a class, the teacher may add information about the class, including a name of the class in field 922, a course name in field 924 (e.g., a course description, such as “Science”), a grade level in field 926 (e.g., 7^{th} grade), a school at field 928, a class code at field 930, a start date at field 932, and an optional end class date at field 934. The class code field 930 may, in various embodiments, be automatically generated by the presentation system 10, but may be edited by the teacher (e.g., to remove combinations of letters and numbers that may create an offensive word). The class code is used, in a particular embodiment, by participants to log into the class and/or lesson on the mobile computing devices 30 (FIG. 1).

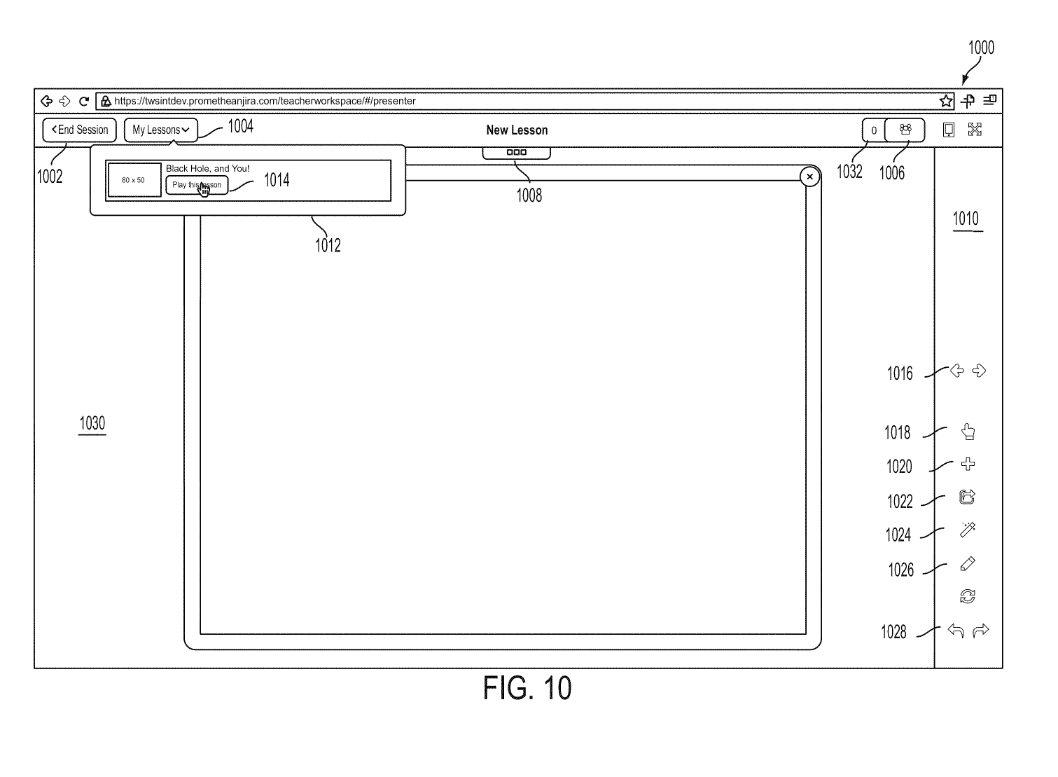

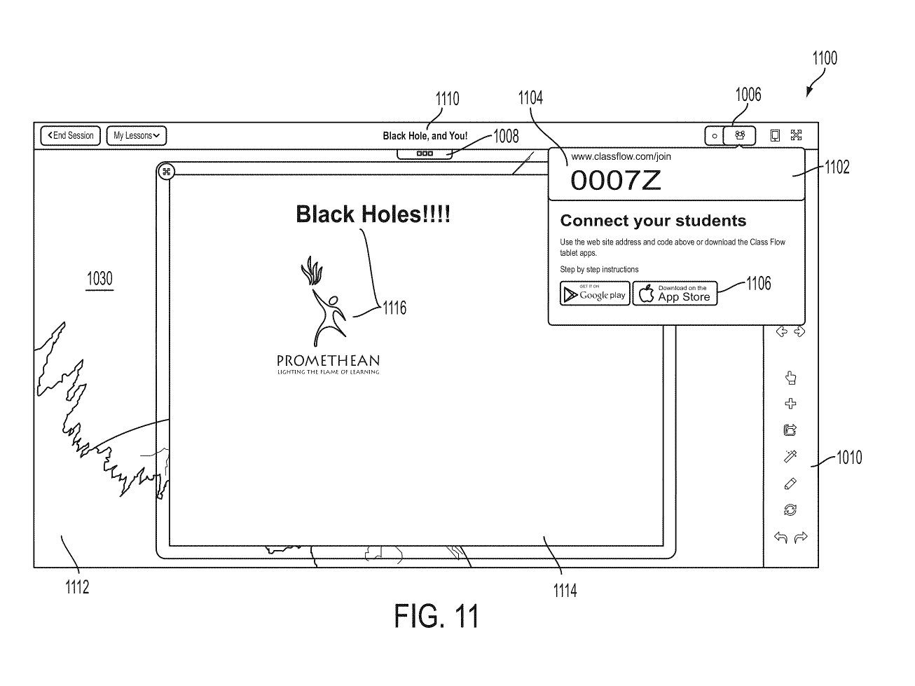

Referring to FIG. 10, when the presentation is in the presentation mode, the screen 1000 includes an End Session button 1002, a My Lesson button 1004, a class code button 1006, a preview button 1008 and an editing palette 1010. When the user selects the My Lesson button 1004, a list of lessons opens in a box 1012. The user can select a lesson (e.g., Black Hole, and You!) and play the lesson by selecting a Play Lesson button 1014. Once the Play Lesson button 1014 is selected by the user, the lesson slides are displayed in the presentation display area 1030. Once the lesson begins, the user may select the preview button 1008, which will open a preview area that displays the various slides in the lesson. The class code button 1006, when selected opens a class code screen (FIG. 11) that displays the class code associated with the class in which the lesson is being displayed. Adjacent to the class code button 1006 is an indicator 1032 that shows the number of viewer devices that are taking part in the presentation session.

The editing palette 1010 contains a multitude of tools that the user can use during the presentation of the slide presentation. The first tool button 1016 allows the user to advance to the next slide or to return to the prior slide. The second tool button 1018 is a selection button that allows the user to select an object contained on a slide. Tool button 1020 allows a user to add a new slide into the slide presentation during the presentation of the slides to viewers. Tool button 1022 allows the user to send an electronically editable version of the slide being displayed to the viewers' associated mobile computing devices. Tool button 1024, when selected, opens an annotation window that allows the user to select the color and brush type when making annotations to the slide in the slide presentation. Tool button 1026 allows the user to write on one or more of the slides or the background of the presentation using a pointing device. In various embodiments, the pointing device may be a mouse, a pen, the user's or a student's finger, a gesture device or any other suitable input device for making annotations to the slides. Finally, tool button 1028 allows the user to undo or redo a change.

FIG. 11 depicts a presentation screen 1100 that includes a presentation display area 1030 in which the teacher started the presentation. In this example, the first slide 1114 of the presentation is being displayed in a presentation display area 1030 in conjunction with a code display window 1102. In various embodiments, the code display window 1102 opens automatically when the first slide of the display is shown. In other embodiments, the code display window opens when the user selects the class code button 1006 (FIG. 10). It should be understood that the presentation screen 1100 may be displayed in a classroom on an interactive display, on a display screen at a conference, on a display screen that is remote from the teacher/presenter, etc. The interactive display may be touch monitor, a touch whiteboard, or any other suitable touch display.

The presentation screen 1100 also includes a lesson title 1110, a background 1112, the slide 1114 displayed against the background 1112, one or more objects 1116 that are on the slide, and the editing palette 1010. The code display window 1102 includes a class code 1104, which one or more viewers (e.g., one or more students) taking the lesson may use to log in to the presentation system in order to receive portions of the lesson on their mobile computing device. The code display window 1102 also includes one or more download options 1106, which displays one or more applications (e.g., via “Google Play”) that the viewers may use to download an application that allows their mobile computing device to connect with the presentation system (e.g., the one or more viewers enters the class code 1104 into the application to view/receive slides of the presentation). The teacher may use the preview button 1008 to access a preview area, which displays a preview (e.g., thumbnail versions of the slides and backgrounds in the presentation) of the one or more backgrounds and/or slides of the presentation. The teacher may additionally freely add any suitable one or more objects to the slide 1114 via one or more tools buttons displayed on the editing palette 1010.

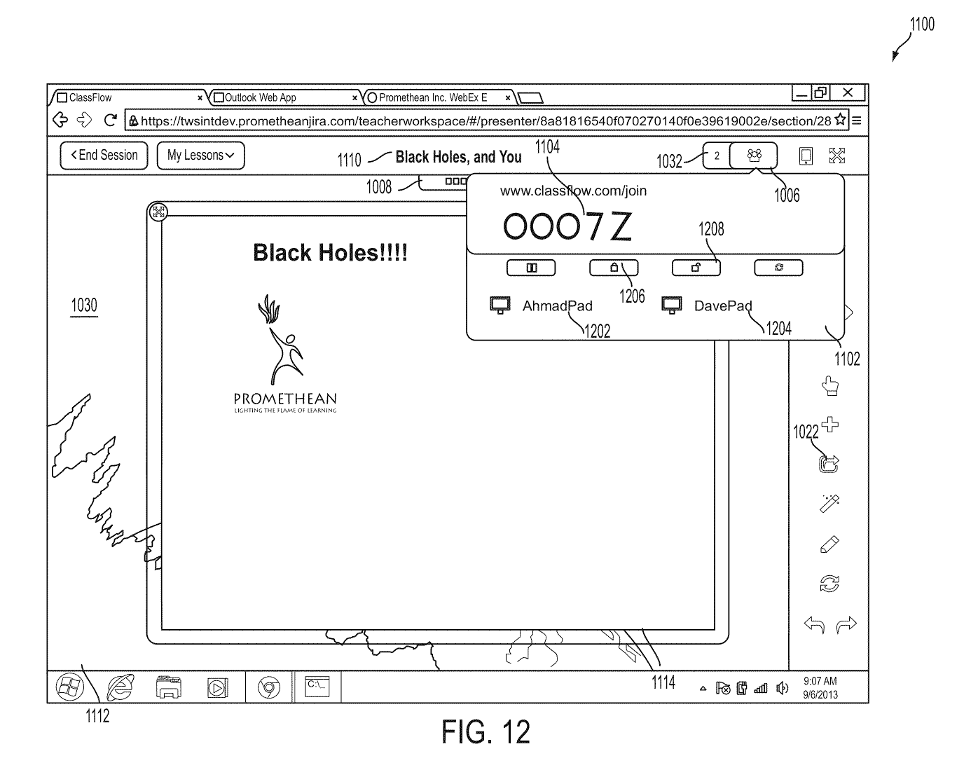

FIG. 12 depicts the presentation screen 1100 (of FIG. 11) wherein one or more viewers 1202 and 1204 have joined the presentation. In particular, the user may be notified when viewers have joined the presentation by the indicator 1032, which shows that 2 viewers have joined the presentation. Thus, when the user selects the class code button 1006, the code display window 1102 opens and displays the representation of the viewer's 1202 and 1204 that have joined. In various embodiments, the user may select the class code button during the presentation and select one or more of the displayed viewers. Once the viewers are selected, the user may select the send slide tool button 1022, which will cause the presentation system to send the currently displayed slide 1114 to the selected viewers. The code display window 1102 also contains one or more buttons 1206 and 1208 that allow the user to lock and unlock the connected mobile computing devices. That is, during a presentation, the user can control whether the viewer can use other features of the mobile computing device during the presentation. Thus, when the user locks the viewers' mobile computing device, the only functionality available to the viewers on the mobile computing devices is to participate in the presentation.

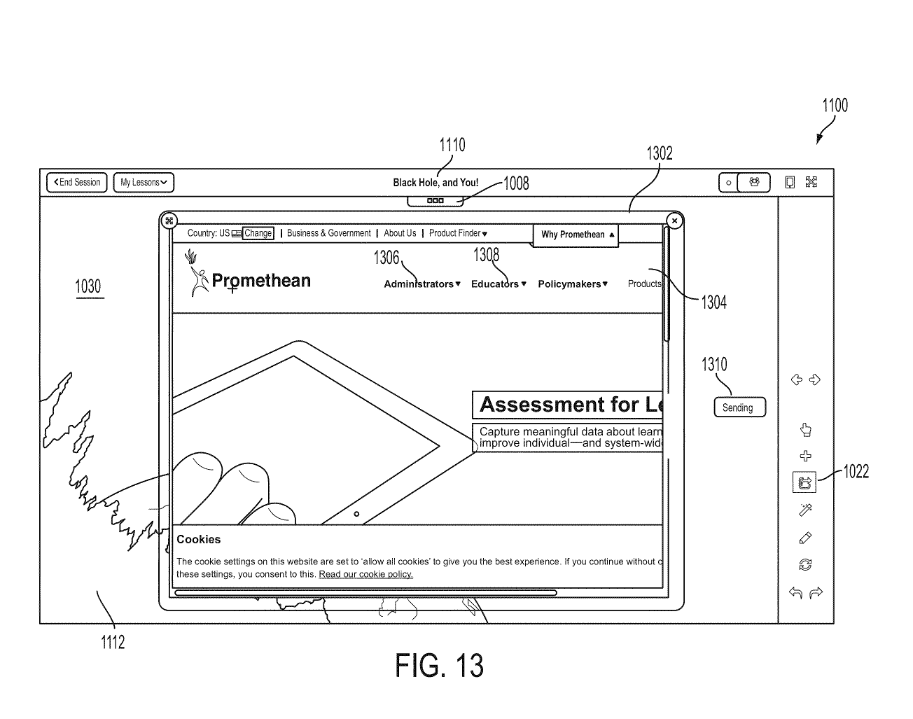

FIG. 13 depicts the presentation screen 1100 displaying a slide 1302 in the presentation display area 1030, where the slide contains an object (e.g., a live webpage) 1304 as an object on the slide. In the embodiment shown, the object 1304 is a live website (e.g., a website with live links 1306, 1308, etc.), and the slide is shown against the background 1112. In various embodiments, the teacher may send the currently displayed slide 1302 to all of the viewers' mobile computing devices by not selecting particular viewers, but, instead, by merely selecting the send slide tool button 1022. In this way, the presentation system may be configured to send an electronically editable version of the slide to each of the connected viewers. In some embodiments, an indicator 1310 may let the user know that the slide is in the process of being sent.

### CONCLUSION

Many modifications and other embodiments of the invention will come to mind to one skilled in the art to which this invention pertains having the benefit of the teachings presented in the foregoing descriptions and the associated drawings. In light of the above, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

What is claimed is:

1. A computer-implemented method of interactively presenting information to one or more viewers, the method comprising:
a. receiving, by at least one processor, a selection by a user of a slide presentation to present to the one or more viewers, the slide presentation comprising one or more slides;
b. facilitating, by at least one processor, presentation of the one or more slides to the one or more viewers; and
c. during presentation of the one or more slides to the one or more viewers, electronically distributing, by at least one processor, an electronic version of at least one particular slide of the one or more slides to the one or more viewers;
wherein the at least one particular slide is selected from a group consisting of:
i. an electronically editable version of one of the one or more slides in the slide presentation;
ii. an electronically non-editable version of one of the one or more slides in the slide presentation;
iii. an electronically editable slide that contains test questions on subject matter covered by the slide presentation;
iv. an electronically editable slide that contains subject matter that is similar to the subject matter covered by the slide presentation;
v. an electronically editable slide that requires the one or more viewers to draw a picture that is related to the subject matter covered by the slide presentation; and
vi. an electronically editable slide that contains an activity that is related to the subject matter covered by the slide presentation.

2. The computer-implemented method of claim 1, wherein facilitating presentation further comprises displaying the one or more slides on an interactive display, wherein a slide comprises one or more objects that are configured to be manipulated by one or more of the user and the one or more viewers during presentation of the one or more slides.

3. The computer-implemented method of claim 1, wherein:
a. the user is a teacher of a class; and
b. the one or more viewers are students taking the class.

4. The computer-implemented method of claim 1, wherein each of the one or more slides of the slide presentation comprise one or more live media objects selected from the group consisting of:
a. one or more webpages;
b. one or more videos;
c. one or more audio files;
d. one or more documents;
e. one or more activities;
f. one or more test questions; and
g. one or more annotations.

5. The computer-implemented method of claim 4, further comprising enabling the user to modify at least one of the one or more live media objects of at least one of the one or more slides.

6. The computer-implemented method of claim 1, wherein each of the steps is executed by the same at least one processor.

7. The computer-implemented method of claim 2, wherein:
a. the at least one particular slide is an electronically editable slide that contains subject matter that is similar to the subject matter covered in the slide presentation,
b. the method further comprises during presentation and after distributing the at least one particular slide, receiving, by at least one processor, an edited version of the at least one particular slide from each one of the one or more viewers.

8. The computer-implemented method of claim 7, wherein facilitating presentation further comprises displaying at least one of the edited versions of the at least one particular slide during the presentation of the one or more slides.

9. The computer-implemented method of claim 2, wherein
a. the electronic version of the at least one particular slide is an electronically editable slide that contains test questions on the subject matter covered by the slide presentation; and
b. the one or more viewers is a particular one of the one or more viewers.

10. The computer-implemented method of claim 9, wherein:
a. during the presentation and after distributing the at least one particular slide to the particular one of the one or more viewers, receiving an edited version of the at least one particular slide from the particular one of the one or more viewers; and
b. the facilitating presentation further comprises displaying the edited version of the at least one particular slide from the particular one of the one or more viewers during display of the one or more slides of the slide presentation.

11. The computer-implemented method of claim 1, wherein electronically distributing further comprises establishing, by at least one processor, a network connection between at least one computer and a mobile computing device associated with each of the one or more viewers.

12. The computer-implemented method of claim 11, wherein establishing the network connection further comprises:
a. generating, by at least one processor,
i. a code that is associated with either of the user and the slide presentation, and
ii. a unique session code that is associated with the presentation of the one or more slides,
b. receiving, by at least one processor, the code and an identifier that is unique to each mobile computing device associated with a respective one of the one or more viewers; and
c. using the session code and the identifier, by at least one processor, to route electronic communications between the user and the one or more viewers.

13. The computer-implemented method of claim 12, wherein electronically distributing further comprises using, by at least one processor, the unique session code and the unique identifier for each mobile computing device to identify mobile computing devices that should receive the at least one particular slide.

14. The computer-implemented method of claim 13, wherein electronically delivering the at least one particular slide further comprises electronically distributing, by the at least one processor:
a. a first particular slide to a first group of viewers of the one or more viewers using the session code and a first group identifier; and
b. a second particular slide to a second group of viewers of the one or more viewers using the session code and a second group identifier.

15. The computer-implemented method of claim 14, further comprising determining the viewers in the first group and the second group by one of:
a. automatically, by at least one processor, based on one or more viewer criteria selected from a group consisting of:
i. at least one response from a viewer to a question asked during presentment of the slide presentation,
ii. random selection,
iii. a viewer's grade point average,
iv. a viewer's style of learning,
v. a viewer's primary language,
vi. a viewer's prior test results, and
vii. information from social networks; and
b. manually, by the user, at a time selected from a group consisting of:
i. during the presentation of the one or more slides, and
ii. prior to presentation of the one or more slides.

16. A computer-implemented method of presenting information to at least two groups of viewers, the method comprising:
a. receiving, by at least one processor, a selection by a user of a slide presentation to present to the at least two groups of viewers, the slide presentation comprising one or more slides;
b. generating, by at least one processor, a code that is associated with one of the user and the slide presentation;
c. facilitating, by the at least one processor, presentation of the code and the slide presentation to the at least two groups of viewers;
d. receiving, by at least one processor, the code and an identifier that is unique to a mobile computing device associated with each viewer in the at least two groups of viewers;
e. generating a session code for the presentation of the slide presentation to the at least two groups of viewers;
f. displaying, by at least one processor, the one or more slides on at least one interactive display; and
g. during the presentation of the one or more slides, distributing, by at least one processor:
i. first electronic information related to the one or more slides to the mobile computing devices associated with each viewer in a first group of viewers in the at least two groups using the session code and a group identifier, and
ii. second electronic information related to the one or more slides to the mobile computing devices associated with each viewer a second group of viewers in the at least two groups using the session code and second group identifier.

17. The computer-implemented method of claim 16, wherein:
a. the first electronic information is a first electronically editable slide that is related to the slide presentation; and
b. the second electronic information is a second electronically editable slide that is related to the slide presentation,
wherein the first electronically editable slide is different from the second electronically editable slide.

18. The computer-implemented method of claim 16, wherein:
a. the first electronic information is an electronically editable version of one particular slide of the one or more slides; and
b. the second electronic information is an electronically editable version of the one particular slide of the one or more slides.

19. The computer-implemented method of claim 18, further comprising, during the presentation of the one or more slides and after distributing the first electronic information and the second electronic information, receiving, by at least one processor, an edited version of the one particular slide from at least one of the viewers in the first group and the second group.

20. The computer-implemented method of claim 16, wherein the user is a teacher teaching a class and the viewers in the first group and the second group are students taking the class.

21. The computer-implemented method of claim 20, further comprising determining which students are in the first and second groups by one of:
a. automatically, by at least one processor, based on one or more student criteria selected from a group consisting of:
i. at least one response from a viewer to a question asked during presentment of the slide presentation,
ii. random selection,
iii. a viewer's grade point average,
iv. a viewer's style of learning,
v. a viewer's primary language,
vi. a viewer's prior test results, and
vii. information from social networks; and
b. manually, by the teacher, at a time selected from a group consisting of:
i. during the presentation of the one or more slides, and
ii. prior to presentation of the one or more slides.

22. The computer-implemented method of claim 16, wherein the user is a businessperson and the viewers in the first and second groups are selected from a group consisting of:
a. business colleagues;
b. vendors; and
c. customers.

23. A system for interactively presenting information to a plurality of viewers, the system comprising:
a. a plurality of processors;
b. memory operatively coupled to the plurality of processors;
c. at least one interactive display,
wherein the system is configured to:
i. receive, by a user, a selection of a slide presentation stored in memory to be presented to the plurality of viewers, wherein the slide presentation contains one or more slides;
ii. facilitate a display of the one or more slides on the at least one interactive display;
iii. during the display of the one or slides to the plurality of viewers, electronically distribute an electronically editable slide to at least one of the plurality of viewers; and
iv. during the display of the one or more slides and after distributing the electronically editable slide, display, on the at least one interactive display, edits made to the electronically editable slide by the at least one of the plurality of viewers.

24. The system of claim 23, wherein the electronically editable slide is a version of a particular slide of the one or more slides of the slide presentation.

25. The system of claim 24, wherein the system is further configured to receive, prior to displaying the edits, one of:
a. an edited version of the particular slide from the at least one of the plurality of viewers; and
b. the edits made to the electronically editable version of the particular slide from the at least one of the plurality of viewers.

26. The system of claim 23, wherein the system is further configured to:
a. receive, prior to displaying the edits, an edited electronically editable slide from each of the plurality of viewers; and
b. display at least one or more of the edited electronically editable slides received from each of the plurality of viewers substantially simultaneously on the at least one interactive display.

27. The system of claim 23, wherein the system is further configured to:
a. generate a code that is associated with one of the user and the slide presentation, wherein the code is displayed to the plurality of viewers prior to the display of the one or more slides;
b. receive the code and an identifier that is unique to a respective mobile computing device associated with each one of the plurality of viewers; and
c. generate a session code that is unique to the display of the one or more slides to the plurality of viewers;
wherein distributing the electronically editable slide further comprises:
i. distributing a first electronically editable slide to a first group of viewers of the plurality of viewers using the session code and a first group identifier, and
ii. distributing a second electronically editable slide to a second group of viewers using the session code and second group identifier.

28. The computer system of claim 23, wherein facilitating the display of the one or more slides further comprises using a web browser to display the one or more slides.

29. The computer system of claim 23, wherein each of the one or more slides of the slide presentation comprises one or more live media objects selected from the group consisting of:
a. one or more webpages;
b. one or more videos;
c. one or more audio files;
d. one or more documents;
e. one or more activities;
f. one or more test questions; and
g. one or more annotations.
